(19) United States
(12) Patent Application Publication
(10) Pub. No.: US 2024/0086757 A1
(43) Pub. Date: Mar. 14, 2024

(54) UTILIZING MACHINE LEARNING MODELS TO PREDICT MULTI-LEVEL CLIENT INTENT CLASSIFICATIONS FOR CLIENT COMMUNICATIONS

(71) Applicant: Chime Financial, Inc., San Francisco, CA (US)

(72) Inventors: Lei Pei, Sunnyvale, CA (US); Jiby Babu, Leander, TX (US); Niranjan A. Shetty, Berkeley, CA (US)

(21) Appl. No.: 17/930,614

(22) Filed: Sep. 8, 2022

(51) Int. Cl. G06N 20/00; G06F 40/30; G06K 9/62

(52) U.S. Cl. CPC G06N 20/00; G06F 40/30; G06K 9/628

(57) ABSTRACT

The present disclosure relates to systems, non-transitory computer-readable media, and methods for utilizing a machine-learning model to determine predicted multi-level client intent classifications and provide a graphical user interface including selectable options for the predicted multi-level client intent classifications. In particular, in one or more embodiments, the disclosed systems utilize the machine-learning model to generate predicted multi-level client intent classifications and corresponding multi-level client intent classification probabilities. The disclosed systems can provide the multi-level client intent classifications to an agent device via a graphical user interface. Moreover, the disclosed systems can make recommendations and/or take action based on the predicted multi-level client intent classifications and corresponding multi-level client intent classification probabilities.

### BACKGROUND

Recent years have seen significant improvements in conventional systems for utilizing various computing devices to interact and interpret interactions across computer networks. For example, conventional systems can utilize heuristic menu structures to guide users through various options and identify desired information or services. Similarly, conventional systems can provide a menu of selectable user interface elements that allow agent devices to identify a particular purpose or reason for a client device interaction. For example, in response to an agent selection of a first category, conventional systems often present menus and various sub-menus of categories to navigate through to identify a purpose or reason for a client device interaction.

Although conventional systems can provide various menu structures to agent devices, these conventional systems have a number of problems in relation to accuracy, efficiency, and flexibility of implementing computing devices. For instance, conventional systems are often inaccurate in categorizing a client device communication or interaction from the provided menus. For example, conventional systems often provide hierarchal menus with thousands of branches and classification combinations that are difficult to navigate and, accordingly, fail to provide the needed categorization and result an inaccurate selection. Indeed, because conventional systems broadly generalize menu and sub-menu options this often leads agent devices to make categorizations that are inapplicable and inaccurate.

In addition, conventional systems are also inefficient. For example, implementing devices often require a significant amount of time and user interactions to identify a category or classification of a digital communication from a client device. Indeed, conventional systems often require excessive user interactions at agent devices to move back and forth between various menus and sub-menus to access different categories in a hierarchal categorization. In conventional systems, the litany of steps required for the system to narrow down the reason for the client contact results in excessive interactions and wasted computing resources.

In addition, conventional systems are often inflexible and rigid. For example, conventional systems often utilize a rigid menu structure of options that agent devices must utilize in order to obtain pertinent information. Accordingly, conventional systems inflexibly present this menu of options to agent devices regardless of the nature or context of the interaction. This inflexibility exacerbates the accuracy and efficiency concerns discussed above.

These along with additional problems and issues exist with regard to conventional systems.

### BRIEF SUMMARY

Embodiments of the present disclosure provide benefits and/or solve one or more of the foregoing or other problems in the art with systems, non-transitory computer-readable media, and methods for utilizing a machine learning model to categorize client device communications into a multi-level intent classification from a hierarchal intent architecture. More specifically, in one or more embodiments, the disclosed systems extract features corresponding to the communication, including text corresponding to the communication and features of the client device that sent the communication. Further, in some embodiments, the disclosed systems utilize a machine learning model to determine multi-level intent classifications for the client device and corresponding multi-level client intent classification probabilities. Additionally, in one or more embodiments, the disclosed systems select predicted multi-level intent classifications for presentation within a graphical user interface of an agent device. Accordingly, the disclosed systems can facilitate efficient and accurate categorization of client device communications within a hierarchal intent architecture.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment for implementing an intent classification system in accordance with one or more embodiments.

FIG. 2 illustrates an example diagram of an intent classification system that utilizes a machine learning model to generate multi-level intent classifications in accordance with one or more embodiments.

FIG. 3 illustrates an example diagram of an intent classification system selecting predicted client multi-level intent classifications from a hierarchical intent architecture in accordance with one or more embodiments.

FIGS. 4A-4B illustrate an example graphical user interface on an agent device displaying predicted multi-level intent classifications in accordance with one or more embodiments.

FIG. 5 illustrates an example diagram of an intent classification system training a machine learning model in accordance with one or more embodiments.

FIG. 6 illustrates an example diagram of an intent classification implementing a machine learning model to predict multi-level intent classifications in accordance with one or more embodiments.

FIG. 7 illustrates an example series of acts for utilizing a machine-learning model to determine multi-level client intent classifications in accordance with one or more embodiments.

FIG. 8 illustrates a block diagram of a computing device for implementing one or more embodiments of the present disclosure.

FIG. 9 illustrates an example environment for an intent classification system in accordance with one or more embodiments.

### DETAILED DESCRIPTION

This disclosure describes one or more embodiments of an intent classification system that utilizes a trained machine learning model to predict multi-level client intent classifications and generate a graphical user interface providing selected multi-level client intent classifications to agent devices. To illustrate, the intent classification system can utilize a machine learning model including a transformer encoder and a classification layer to analyze text from a client device communication. For example, the intent classification system can extract features from communications (and an associated client device) and analyze those features utilizing a machine learning model to generate predicted multi-level client intent classifications and corresponding multi-level client intent classification probabilities. Furthermore, the intent classification system can utilize the multi-level client intent classification probabilities to select multi-level client intent classifications to provide in one or more graphical user interfaces. Additionally, in one or more embodiments, the intent classification system tracks agent selections of the multi-level client intent classifications and utilizes these selections to further train the machine learning model. Accordingly, the intent classification system can improve the efficiency, accuracy, and flexibility of implementing computing devices in managing, addressing, and responding to client communications.

As just mentioned, the intent classification system analyzes communication text and corresponding features of one or more associated client devices. In particular, the intent classification system utilizes these features in a machine learning model to generate predicted multi-level client intent classifications. For instance, the intent classification system can extract text from various fields in a communication (e.g., digital email or text) and identify an associated client device or user account. Further, in one or more embodiments, the intent classification system retrieves user interactions, user characteristics, and other user data. To illustrate, in response to receiving a communication, the intent classification system can determine a client's recent activity or previous multi-level client intent classifications from prior communications.

Upon extracting text and determining client features, the intent classification system utilizes a machine learning model to generate predicted multi-level client intent classifications. For example, in one or more embodiments, the intent classification system utilizes a BERT or DistilBERT machine learning model. To illustrate, the intent classification system can utilize a machine learning model with a transformer encoder and one or more classification layers. In one or more embodiments, the intent classification system utilizes a trained machine learning model to analyze the extracted text and extracted characteristics to generate predicted multi-level client intent classifications and corresponding multi-level client intent classification probabilities. For instance, the machine learning model can predict a contact reason that includes multiple different classification layers (e.g., from a broad, generic layer to a more specific classification layer) within a hierarchical intent structure.

In one or more embodiments, the intent classification system can select multi-level client intent classifications for presentation in a graphical user interface based on corresponding multi-level client intent classification probabilities. In one or more embodiments, the intent classification system provides these multi-level client intent classifications to an agent device for association with the corresponding communication. In some embodiments, the intent classification system utilizes one or more thresholds to select multi-level client intent classifications for presentation via a graphical user interface. In addition, or in the alternative, the intent classification system selects a predetermined number of top multi-level client intent classifications with the highest corresponding multi-level client intent classification probabilities.

Additionally, in one or more embodiments, the intent classification system utilizes the predicted multi-level client intent classifications and corresponding multi-level client intent classification probabilities to perform a variety of automatic processes. For example, the intent classification system generates an automated reply to the communication, takes an action associated with a selected multi-level client intent classification, or routes communications to a particular client device (e.g., a specialized agent device). In addition, or in the alternative, the intent classification system utilizes a multi-level client intent classification probability to provide a confidence notification to an agent device indicating a confidence in a predicted multi-level client intent classification.

In one or more implementations, the intent classification system determines multi-level client intent classifications from a hierarchical intent architecture. Indeed, the intent classification system can maintain a plurality of multi-level client intent classifications in various layers. For instance, the intent classification system can organize broad multi-level client intent classifications on a first layer, more narrow multi-level client intent classifications on a second layer, and even more specific multi-level client intent classifications on a third layer. In one or more embodiments, the intent classification system generates a multi-level client intent classification that includes preceding layers and classes. Thus, for a multi-level client intent classification for a fourth layer can include a classification chain or path within a hierarchical intent architecture that includes classes from the first layer, the second layer, the third layer, and the fourth layer.

In one or more implementations, the intent classification system generates multi-level client intent classifications by selecting multi-level client intent classifications from different layers of this hierarchical intent architecture. To illustrate, the intent classification system can generate a first multi-level client intent classification from a first layer of the hierarchical intent architecture and a second multi-level client intent classification from a second layer of the hierarchical intent architecture. Accordingly, the intent classification system can dynamically generate multi-level client intent classifications at different levels of specificity (e.g., depending on the confidence of predictions at different layers and the amount of training data corresponding to different layers).

As mentioned above, the intent classification system can train the machine learning model. In some embodiments, the intent classification system trains the machine learning model to utilize communication text and extracted client features as inputs together with ground truth classifications for supervised training. In some implementations, the intent classification system utilized predicted multi-level client intent classifications from a communication and monitored user interactions from a corresponding agent device, client device or user account to further train the machine learning model. More specifically, the intent classification system can utilize agent selection of provided multi-level client intent classifications and the associated communication text and client features to further train the machine learning model.

As suggested above, the disclosed intent classification system provides several improvements or advantages over conventional systems. For example, the intent classification system can improve the inaccuracy of conventional systems by predicting multi-level client intent classifications and providing selected predicted multi-level client intent classifications to an agent device. For example, by utilizing a trained machine learning model, communication text, and extracted features corresponding to the communication, the intent classification system can predict an accurate client intent corresponding to the communication. Accordingly, the intent classification system can utilize implementing computer devices to determine and provide accurate data to client devices, including agent devices.

In addition, the intent classification system can improve inefficiencies of conventional systems by reducing the overall burden on implementing devices. For example, the intent classification system can utilize a trained machine learning model to generate predicted multi-level client intent classifications. Accordingly, the intent classification system can reduce interaction times, user interfaces, and computing resources in interacting with client devices. In particular, the intent classification system can reduce excessive interactions required of agent devices when navigating through a large hierarchy of multi-level client intent classifications. Indeed, by reducing the number of user inputs, interfaces and interaction times, the intent classification system can reduce unnecessary burdens on computing resources.

Moreover, the intent classification system can also improve accuracy and efficiency of downstream resources that rely upon user communication categorizations. Indeed, the intent classification system can utilize classifications from agent devices to further train machine learning models, to provide notifications to client devices, or to modify pipelines and computer processes to address client feedback. Indeed, in contrast to conventional systems that undermine the efficiency of these downstream tasks through inaccurate classifications, the intent classification system provides accurate information that makes machine learning models converge more quickly and efficiently, reduces inaccurate notifications, and allows for more precise, efficient modification of processes to address client feedback.

The intent classification system can also improve the inflexibility and rigidity of conventional systems. For example, the intent classification system can generate multi-level client intent classifications and perform automatic system action based on corresponding multi-level client intent classification probabilities. In doing so, the intent classification system can flexibly bypass rigid menus or operational structures that plague conventional systems. Indeed, the intent classification system can flexibly generate responses to communications and/or flexibly route client devices to agent devices to access specific resources. Moreover, as discussed above, the intent classification system can determine multi-level client intent classifications from different levels of a hierarchical structure to flexibly provide options to client devices and/or agent devices that allow computing devices to dynamically bypass rigid options associated with conventional systems.

As illustrated by the foregoing discussion, the present disclosure utilizes a variety of terms to describe features and advantages of the intent classification system. Additional detail is now provided regarding the meaning of such terms. For example, “multi-level client intent classification” refers to a class or category indicating a purpose, disposition, intent, reason, or objective for a communication (from a hierarchical intent architecture). In particular, a multi-level client intent classification can include a probable intention of the client at a particular layer of specificity, determined by a machine learning model trained on past interaction and informed by communication text and client features. To illustrate, a multi-level client intent classification can include a prediction that the intent of a received communication is to inquire about a direct deposit status, interaction history, and/or device fee information. In some implementations, a multi-level client interaction classification includes a prediction of an intent at a particular layer of a hierarchical intent architecture that includes a chain or path of preceding layers/classes from the hierarchical intent architecture.

Additionally, as used herein, the term “communication” refers to a message corresponding to a client device. In particular, the term “communication” can include a message sent to the intent classification system including text and corresponding to a user account. To illustrate, a communication can include a support ticket, an email, an instant message, a text, or a variety of digital communications including text.

Further, as used herein, the term “hierarchical intent architecture” refers to a plurality of multi-level client intent classifications organized into a plurality of layers. In particular, the hierarchical intent architecture can include various intent classes in various layers. Each intent class can correspond to additional (e.g., children) intent classes in additional layers. Accordingly, some multi-level client intent classifications are more specific sub-classes within the hierarchal intent architecture.

In one or more embodiments, the intent classification system uses a machine learning model. As used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

In addition, the intent classification system can use a machine learning model to generate a multi-level client intent classification probability. As used herein, the term multi-level client intent classification probability refers to a likelihood of accuracy for a particular multi-level client intent classification. In particular, the multi-level client intent classification probability can include a probability that a communication has a client intent corresponding to a predicted multi-level client intent classification. To illustrate, a multi-level client intent classification probability can include a 65% probability that the purpose of a client communication is to inquire about a direct deposit status.

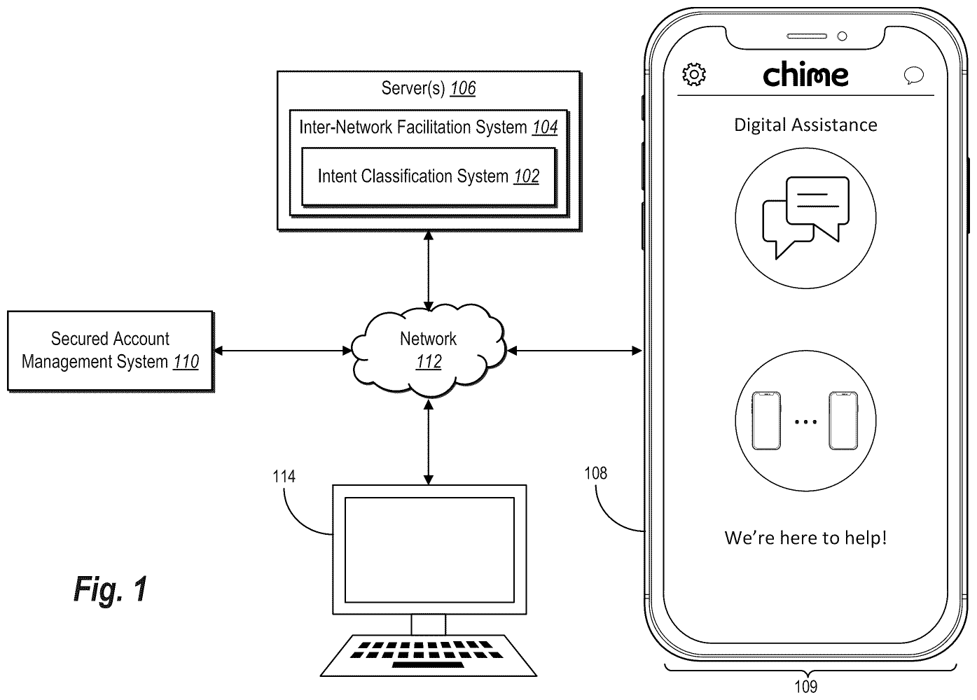

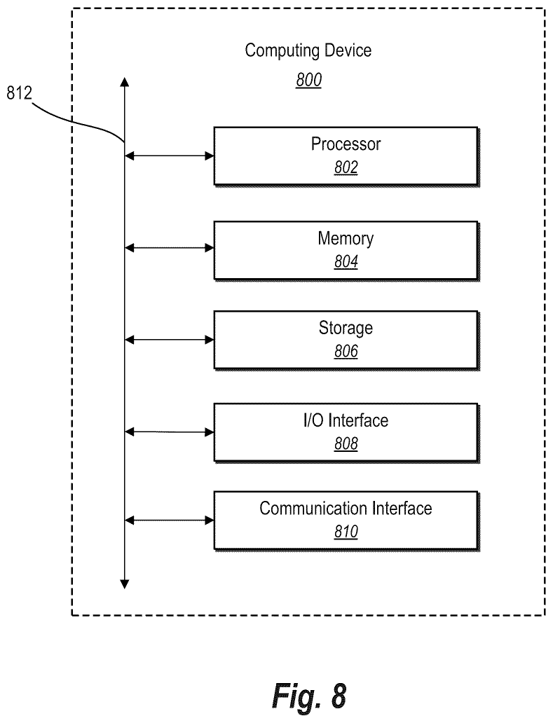

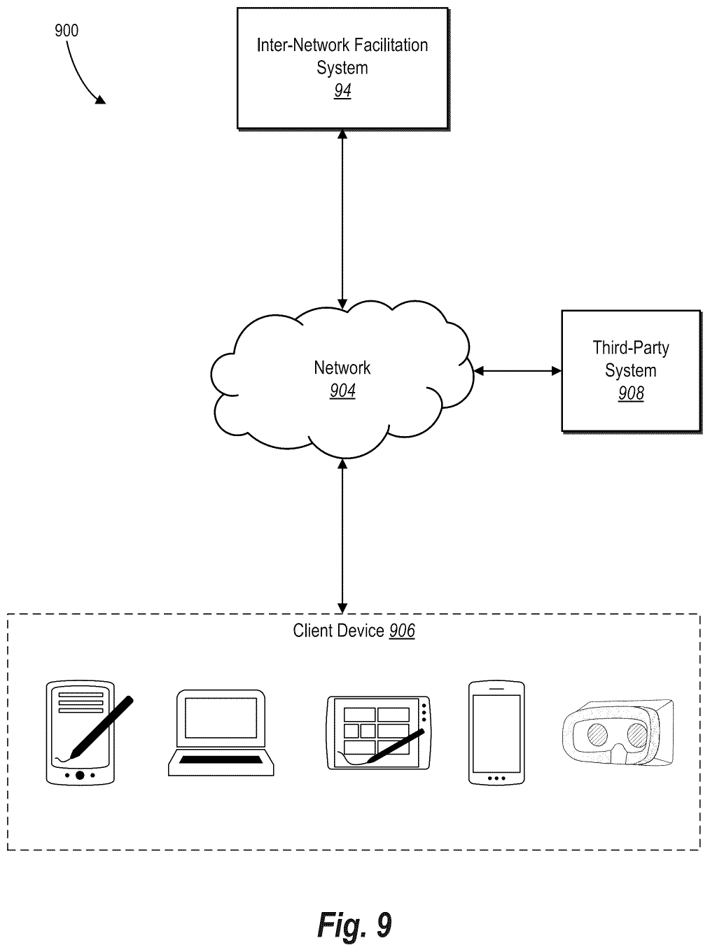

Additional detail regarding the intent classification system will now be provided with reference to the figures. In particular, FIG. 1 illustrates a block diagram of a system environment for implementing an intent classification system 102 in accordance with one or more embodiments. As shown in FIG. 1, the environment includes server(s) 106 implementing the intent classification system 102 part of an inter-network facilitation system 104. The environment of FIG. 1 further includes a client device 108, a device application 109, an agent device 114, and a secured account management system 110. The server(s) 106 can include one or more computing devices to implement the intent classification system 102. Additional description regarding the illustrated computing devices (e.g., the server(s) 106, the client device 108, the agent device 114 and/or the secured account management system 110) is provided with respect to FIGS. 8-9 below.

As shown, the intent classification system 102 utilizes the network 112 to communicate with the client device 108, the agent device 114, and/or the secured account management system 110. The network 112 may comprise a network as described in relation to FIGS. 8-9. For example, the intent classification system 102 communicates with the client device 108 to provide and receive information pertaining to various client interactions. Indeed, the inter-network facilitation system 104 or the intent classification system 102 can provide a predicted multi-level client intent classifications to the client device 108 or can facilitate a session between the agent device 114 and the client device 108.

As described in greater detail below (e.g., in relation to FIG. 9), the inter-network facilitation system 104 can manage interactions across multiple devices, providers, and computer systems. For example, the inter-network facilitation system 104 can execute transactions across various third-party systems such as a banking entities, automated transaction machines, or payment providers. The inter-network facilitation system 104 can also maintain and manage digital accounts for client devices/users to store, manage, and/or transfer funds to other users.

To facilitate generating multi-level client intent classifications, in some embodiments, the inter-network facilitation system 104 or the intent classification system 102 communicates with the secured account management system 110. More specifically, the inter-network facilitation system 104 or the intent classification system 102 determines the identity and permissions of the client device 108 by communicating with the secured account management system 110. The intent classification system 102 can determine permissions of the client device 108 prior to disclosing secure information to the client device 108. For example, the inter-network facilitation system 104 or the intent classification system 102 accesses a secured account maintained by the secured account management system 110 (e.g., remotely from the server(s) 106) and determines the last direct deposit within the secured account.

In one or more embodiments, the inter-network facilitation system 104 or the intent classification system 102 communicates with the secured account management system 110 in response to the intent classification system 102 receiving data (e.g., a communication and corresponding account data) from the client device 108. In particular, the inter-network facilitation system 104 or the intent classification system 102 provides an indication of a secured account associated with a digital account to indicate that the client device 108 is authorized to receive information pertaining to the digital account. In addition, the inter-network facilitation system 104 or the intent classification system 102 communicates with the secured account management system 110 to determine permissions and/or activity of the client device 108. For example, the inter-network facilitation system 104 or the intent classification system 102 provide information to the client device 108 such as direct deposit status, digital account updates, device fee information, check status, interaction history, order status, activation, etc.

As indicated by FIG. 1, the client device 108 includes the device application 109. In particular, the device application 109 can include a web application, a native application installed on the client device 108 (e.g., a mobile application, a desktop application, etc.), or a cloud-based application where all or part of the functionality is performed by the server(s) 106. In some embodiments, the inter-network facilitation system 104 or the intent classification system 102 communicates with the client device 108 through the device application 109. This communication for example, receives and provides information including direct deposit status, digital account updates, device fee information, check status, interaction history, order status, activation, etc. As shown, the intent classification system 102 can provide digital account information and secured account information for display within a graphical user interface associated with the device application 109 or can provide digital account information via other methods.

As shown in FIG. 1, the client device 108 implements the device application 109 in conjunction with interaction with the inter-network facilitation system 104 or the intent classification system 102. For example, the inter-network facilitation system 104 or the intent classification system 102 can monitor the activities of the device application 109. In particular, these activities can include events such as time spent on device application 109, recently viewed pages on device application 109, the most recent activation activity of the device application 109, etc.

Although FIG. 1 illustrates the environment having a particular number and arrangement of components associated with the intent classification system 102, in some embodiments, the environment may include more or fewer components with varying configurations. For example, in some embodiments, the inter-network facilitation system 104 or the intent classification system 102 can communicate directly with the client device 108, device application 109, and/or the secured account management system 110, bypassing the network 112. In these or other embodiments, the inter-network facilitation system 104 or the intent classification system 102 can be implemented (entirely on in part) on the client device 108. Additionally, the inter-network facilitation system 104 or the intent classification system 102 can include or communicate with a database for storing information, such as direct deposit status, digital account updates, device fee information, check status, interaction history, order status, activation, and/or other information described herein.

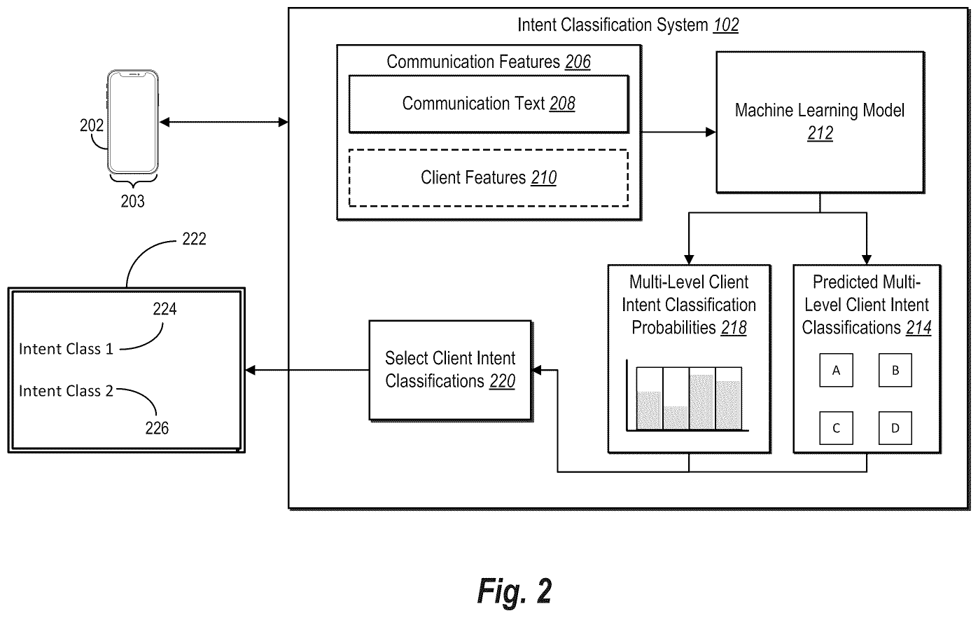

As discussed above, the intent classification system 102 can provide predicted multi-level client intent classifications to an agent device. For example, FIG. 2 illustrates an overview of the intent classification system 102 utilizing a machine learning model 212 to generate multi-level client intent classifications 214 and corresponding multi-level client intent classification probabilities 218 (in real time in response to receiving a communication from a client device). More specifically, as illustrated in FIG. 2, the intent classification system 102 extracts communication features 206 corresponding to a client device 202 and uses the machine learning model 212 to generate predicted multi-level client intent classifications 214 and multi-level client intent classification probabilities 218. The intent classification system 102 utilizes the predicted multi-level client intent classifications 214 and the multi-level client intent classification probabilities 218 to perform an act 220 of selecting client intent classifications. Furthermore, the intent classification system 102 provides two or more (e.g., 2, 3, 4, or 5) intent classes (e.g., the intent classifications 224, 226) for display to an agent device 222.

More specifically, when the client device 202 contacts the intent classification system 102 (e.g., submits a support ticket), the intent classification system 102 determines the identity of the client device 202 either through a device application 203 or through client provided credentials. In particular, client provided credentials can include social security numbers, caller ID, card numbers, personal identification numbers, and other information related to a digital account.

Upon determining a digital account or identity corresponding to the client device 202, the intent classification system 102 extracts the communication features 206 of the communication corresponding to a digital account of the client device 202 or the device application 203. As shown in FIG. 2, the communication features 206 can include communication text 208 and, optionally, client features 210. In some embodiments, the communication text includes the body and/or subject of an email, text in one or more fields of a support ticket, text of an instant message, a transcription of spoken words, or text of a variety of communication types.

In one or more embodiments, the client features 210 can include the last balance, transaction activity, prior or recent direct deposit activity, a maximum/minimum balance (within a threshold time), a maximum/minimum transaction amount (within a threshold time), a number of previous interactions, time since the last dispute update (e.g., a status update corresponding to a dispute), mobile check deposit activity, a fraud or risk score, and/or a number of previous interactions. The client features 210 can include interactive digital text threads (e.g., prior chatbot contacts and intents), calls (e.g., prior dispositions of calls with an interactive voice response system or agent), transactions, card orders and activations, disputes, messages (e.g., customer service topics), account views, log ins, low balance events, authorizations, web contacts, account settings views, settlements, card activity, account creations, or home page views.

The intent classification system 102 can extract the client features 200 from a variety of sources, including a digital account corresponding to a user, the client device 202, and/or a database of historical interactions or information pertinent to a user/client device. For instance, intent classification system 102 can extract the client features 200 from previous interactions with the client device 202 such as phone calls, online-chat sessions on the client device 202 or the device application 203, or user interactions with user interfaces of the device application 203.

Similarly, the intent classification system 102 can extract the communication features 206 including the communication text 208. To illustrate, in one or more embodiments, the intent classification system 102 retrieves text from the body of a communication and any other text associated with the communication. For example, in one or more embodiments, the intent classification system 102 retrieves text from multiple fields of a support ticket form, text from the subject line of an email, metadata text, and/or additional text associated with a communication.

As also shown in FIG. 2, the intent classification system 102 can optionally extract client features 210. In one or more embodiments, the client features 210 include a value metric such as an account balance for a digital account, the value of a direct deposit, the value of a transaction made on the digital account, the value of interest accrued on a digital account, or the value of fees owed. Moreover, the intent classification system 102 can extract the client features 210 from an account status such as whether an account is active, closed, temporarily disabled, on hold, or in default. Furthermore, the intent classification system 102 can extract the client features 200 from recent activity such as the client device 202 contacting the intent classification system 102 or entering an online-chat session (interactive digital text thread), including within a designated time period. In addition, the client features 210 can include information regarding the client device, such as device type (e.g., smartphone or personal computer), operating system, or application version. Moreover, the client features 210 can include user attributes (e.g., age, income, location, etc.).

In some implementations, the intent classification system 102 extracts client features corresponding to base limit value of an account (e.g., a “SpotMe” amount). In particular, the intent classification system 102 can utilize a base limit value, an amount of base limit value utilized, a number of base limit increases transmitted to or from a user account, as described by GENERATING USER INTERFACES COMPRISING DYNAMIC BASE LIMIT VALUE USER INTERFACE ELEMENTS DETERMINED FROM A BASE LIMIT VALUE MODEL, U.S. application Ser. No. 17/519,129, filed Nov. 4, 2021 and DETERMINING BASE LIMIT VALUES FOR CONTACTS BASED ON INTER-NETWORK USER INTERACTIONS, U.S. application Ser. No. 17/656,816, filed Mar. 28, 2022, which are expressly incorporated by reference herein in their entirety. The intent classification system 102 can also utilize activity or usage of other features or services of the inter-network facilitation system 104 (e.g., an account for transferring assets or paying friends or a credit card backed by a secured account).

In one or more embodiments, the intent classification system 102 extracts the client features 210 by comparing historical events/features with current features. For example, the client features 210 can include the time that has passed since a previous event (e.g., time since a previous call, a previous transaction, a previous dispute, a previous message, a previous viewing of an account, a previous log in, a low balance event, a previous authorization, a previous web contact, a previous viewing of account settings, a previous settlement, a card was frozen/unfrozen, an account was created, or a home page was viewed). The intent classification system 102 can also extract other client features such as a transaction amount (over the last threshold period, such as 128 days), a number of views (e.g., a number of home views or spending account views within the last 128 days), or a range over mean balance within a threshold time period.

As illustrated in FIG. 2, upon extracting the communication features 206, the intent classification system 102 utilizes the machine learning model 212 to generate predicted multi-level client intent classifications 214 and multi-level client intent classification probabilities 218. In particular, the intent classification system 102 utilizes the machine learning model 212 to analyze the communication features 206. For example, the intent classification system 102 can encode the client communication features 206 (e.g., using one hot encoding, an encoding layer, or a vector mapping) and then process the encoding utilizing the machine learning model 212.

The intent classification system 102 can utilize a variety of machine learning models to analyze the communication features 206. For example, the intent classification system 102 can utilize a neural network (such as a convolutional neural network), a decision tree, or other machine learning model to process the communication features 206. In some embodiments, the machine learning model 212 is a natural language processing model, such as a transformer model. For instance, in one or more embodiments the intent classification system 102 utilizes BERT or DistilBERT machine learning model architectures. Accordingly, in one or more embodiments, the intent classification system 102 embeds the communication features 206 and inputs the embedded communication features into a transformer encoder of the machine learning model 212. The machine learning model 212 then utilizes classification layers to generate a predicted multi-level client intent classification and corresponding probability or likelihood.

As shown in FIG. 2, the intent classification system 102 utilizes the machine learning model 212 to generate the predicted multi-level client intent classifications 214. The predicted multi-level client intent classifications 214 can include a variety of dispositions or purposes for a client communication. For example, the intent classification system 102 utilizes the machine learning model 212 to predict an intent classification for a communication from a client device related to checking on status of a dispute, becoming eligible for a base limit value (e.g., SpotMe), becoming eligible for credit builder (e.g., a credit card with a linked, secured cash account for building credit), setting up direct deposit, checking status of a direct deposit, depositing money into an account, initiating or checking on a mobile check deposit, initiating a dispute (e.g., regarding a charge or fee), reporting a lost card, activating a card, requesting information regarding a recent deposit, inquiring regarding a recent statement, opening a new account, closing an account, or some other intent. Similarly, multi-level client intent classifications can include an account update, referral bonus query, transfer status, atm location query, direct deposit status (e.g., has an account received a direct deposit), fee information (e.g., information regarding one or more fees associated with the account), check status (e.g., whether or not a check has cleared an account), interaction history (e.g., information regarding recent transactions or other interactions), order status (e.g., status of a particular order or transaction), and activation (e.g., activation of an account, product, card, or service).

To illustrate, the intent classification system 102 can utilize the text from a message to predict a multi-level client intent classification of “fee information” (e.g., ATM fees) as one of the predicted multi-level client intent classifications 214. In one or more embodiments, the intent classification system 102 can further utilize client features to predict a multi-level client intent classification of “fee information.” To illustrate, the intent classification system 102 can also detect client features indicating that a fee was recently applied to an account.

Similarly, the intent classification system 102 can determine “check status” (e.g., check cancellation or check clearance) in response to detecting communication text related to a check and client features indicating that a client recently submitted a check for deposit, has a check scheduled for payment, or has recently called regarding the status of a check. Further, the intent classification system 102 can identify “interaction history” as one of the predicted multi-level client intent classifications 214 upon determining communication text related to recent client interactions and identifying client features showing that the digital account associated with the client device 202 recently made multiple high value transactions, recently had a declined transaction, or recently checked their interaction history on the device application 203. In addition, the intent classification system 102 can identify “order status” as one of the predicted multi-level client intent classifications 214 upon identifying communication text including questions about an order or package and identifying client features showing that the digital account associated with the client device 202 recently ordered a card associated with a digital account. Further, the intent classification system 102 can select the multi-level client intent classification “activation” upon determining communication text asking about using a card or account for the first time and/or client features indicating the digital account associated with the client device 202 recently attempted to activate a digital account or card. Moreover, the intent classification system 102 can determine “dispute” as one of the predicted multi-level client intent classifications 214 in response to identifying communication text indicating that the user did not make a purchase on their account and/or client features indicating the client device 202 recently made a large purchase that does not fit a usual pattern of spending.

In addition to the predicted multi-level client intent classifications 214, the machine learning model 212 also generates the multi-level client intent classification probabilities 218. The multi-level client intent classification probabilities 218 reflect likelihoods that the predicted multi-level client intent classifications 214 correspond to the actual intent of the client. Thus, if the intent classification system 102 predicts “direct deposit status” as the client device's predicted multi-level client intent classification, the intent classification system also generates a corresponding probability (e.g., 45%) as a level of confidence for the actual intent of the communication.

As shown, the intent classification system 102 generates a plurality of multi-level client intent classifications and corresponding intent classification probabilities. For example, the intent classification system 102 utilizes the machine learning model 212 to generate multiple predicted multi-level client intent classifications with a corresponding probability distribution for the predicted classifications.

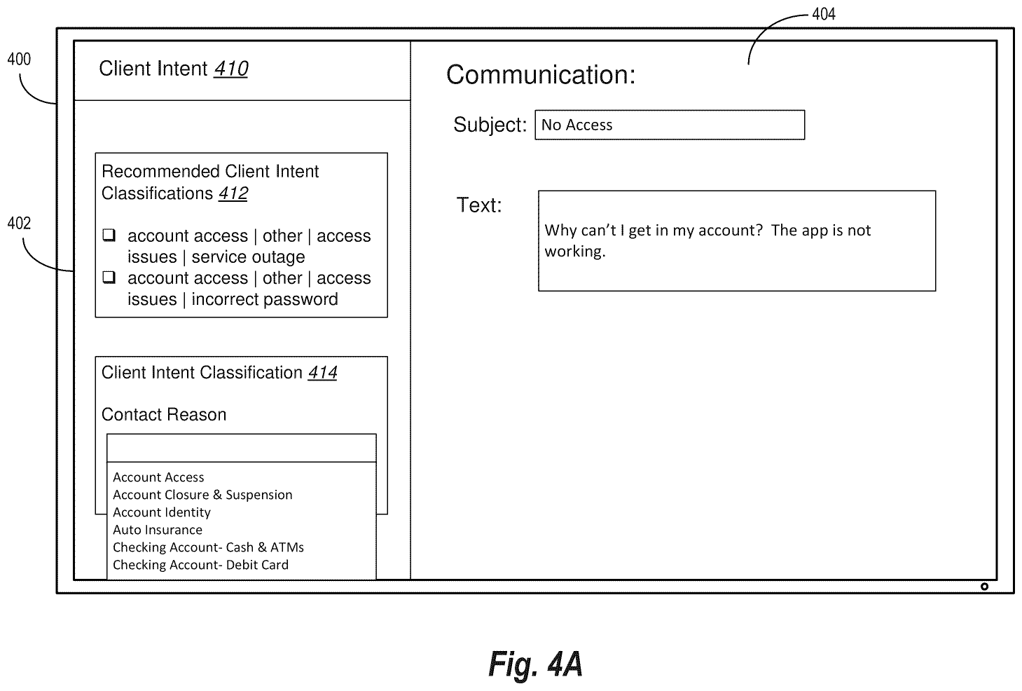

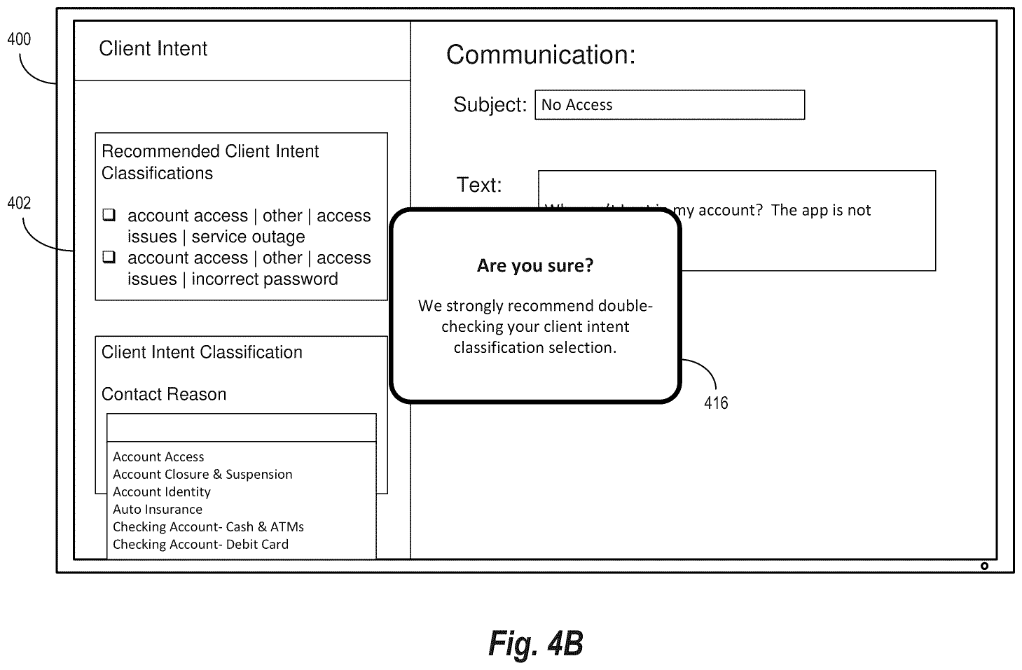

As mentioned, the intent classification system 102 also performs the act 220 of selecting intent classifications. In particular, the intent classification system 102 selects a subset of multi-level client intent classifications from the predicted multi-level client intent classifications 214. As will be discussed below with regard to FIGS. 4A-4B, the intent classification system 102 can provide one or more multi-level client intent classifications for selection in a graphical user interface based on corresponding intent classification probabilities.

In some embodiments, the intent classification system 102 selects a predetermined number of multi-level client intent classifications having the highest multi-level client intent classification probabilities. For example, the intent classification system 102 can utilize a top number (e.g., top 2, 3, or 4) or top percentage (e.g., top 10 or 20 percent) of the predicted multi-level client intent classifications 214. To illustrate, the intent classification system 102 can select the top two, top three, etc. multi-level client intent classifications based on their corresponding multi-level client intent classification probabilities. Thus, the intent classification system 102 can provide the most likely multi-level client intent classifications to an agent device via a graphical user interface.

Additionally, in one or more embodiments, the intent classification system 102 utilizes an intent classification threshold to select predicted multi-level client intent classifications 214. To illustrate, the intent classification system 102 can determine an intent classification threshold of 20%. The intent classification system 102 can then compare intent classification probabilities (i.e., the intent classification probabilities 218) with the intent classification threshold. Thus, the intent classification system 102 can provide each multi-level client intent classification that satisfies the intent classification threshold to an agent device via a graphical user interface.

The intent classification system 102 can identify the predetermined number of multi-level client intent classifications and/or the intent classification threshold in a variety of ways. For example, in some implementations the intent classification system 102 determines the predetermined number of multi-level client intent classifications and/or the intent classification threshold based on user input (e.g., a user interaction selecting a particular number of multi-level client intent classifications or a particular threshold). In other embodiments, the intent classification system 102 determines the predetermined number of multi-level client intent classifications and/or the intent classification threshold based on historical agent selections or based on historical client device activity following communications. For example, the intent classification system 102 can determine a frequency of agent selection of multi-level client intent classifications with particular multi-level client intent classification probabilities and/or with particular rankings among multi-level client intent classifications. The intent classification system 102 can then determine the intent classification threshold to improve (e.g., optimize) the time and/or computer resources for responding to client devices. To illustrate, the intent classification system 102 can exclude multi-level client intent classifications for selection that are unlikely to be selected from presentation within the graphical user interface.

Additionally, in one or more embodiments, the intent classification system 102 can utilize the multi-level client intent classification probabilities 218 to determine whether to take one or more actions. To illustrate, in one or more embodiments, the intent classification system 102 utilizes an intent classification threshold to determine whether to take an action associated with the multi-level client intent classification. In one or more embodiments, the intent classification system 102 determines that the top predicted multi-level client intent classification is associated with a multi-level client intent classification probability that satisfies the intent classification threshold. Based on this determination, the intent classification system 102 can take an action associated with the multi-level client intent classification. For example, the intent classification system 102 generates an automatic reply to the communication with instructions corresponding to the multi-level client intent classification, automatically makes changes to one or more account settings for an account associated with the communication, or refers the communication to a particular device (e.g., a specific agent device corresponding to the classified intent).

Although not illustrated in FIG. 2, in some implementations, the intent classification system 102 utilizes multiple hierarchical intent architectures and multiple machine learning models to generate different predictions at different stages. For example, in response to receiving a client interaction (e.g., a call or chat), the intent classification system 102 can utilize a first machine learning model to determine an initial client disposition/intent. To illustrate, the intent classification system 02 can utilize the approach described by UTILIZING MACHINE LEARNING MODELS TO PREDICT CLIENT DISPOSITIONS AND GENERATE ADAPTIVE AUTOMATED INTERACTION RESPONSES, U.S. application Ser. No. 17/554,795, filed Dec. 17, 2021, which is incorporated herein by reference in its entirety, to determine an initial client disposition from an initial set of intents. These intents can inform automated voice interactions to respond to a client device query. Similarly, the intent classification system 102 can utilize the approach described by UTILIZING MACHINE LEARNING MODELS TO GENERATE INTERACTIVE DIGITAL TEXT THREADS WITH PERSONALIZED DIGITAL TEXT REPLY OPTIONS, U.S. application Ser. No. 17/809,765, filed Jun. 29, 2022, which is incorporated herein by reference in its entirety, to determine an initial client intent from an interactive digital text thread from an initial set of intents. These intents can be utilized to respond to client device queries via an automated digital text thread.

In one or more embodiments, the intent classification system 102 then utilizes an additional machine learning model (as described herein) to generate predictions for an additional (e.g., more specific or granular) hierarchical intent architecture. Thus, the intent classification system 102 utilizes a second machine learning model to generate recommended multi-level client intent classifications to surface to an agent device. The agent device can then select the most appropriate multi-level client intent classification to verify the contact reason for the client interaction. This information can then be utilized for a variety of downstream tasks, including more accurately training machine learning models (e.g., revising the first machine learning models discussed in the previous paragraph), modifying pipelines for addressing client interactions, or providing notifications to client devices (e.g., notifying client devices that there may be additional issues to resolve or to confirm that their query has been resolved). Thus, in some implementations, the intent classification system 102 utilizes a dedicated machine learning model for more accurate ticket classification in conjunction with other machine learning models.

As just mentioned, the intent classification system can utilize multiple different machine learning models for different intent classification tasks. In one or more embodiments, the intent classification system can utilize a single machine learning model to perform these tasks (e.g., a single intent classification model to determine intents for interactive communication and surfacing classifications to an agent device).

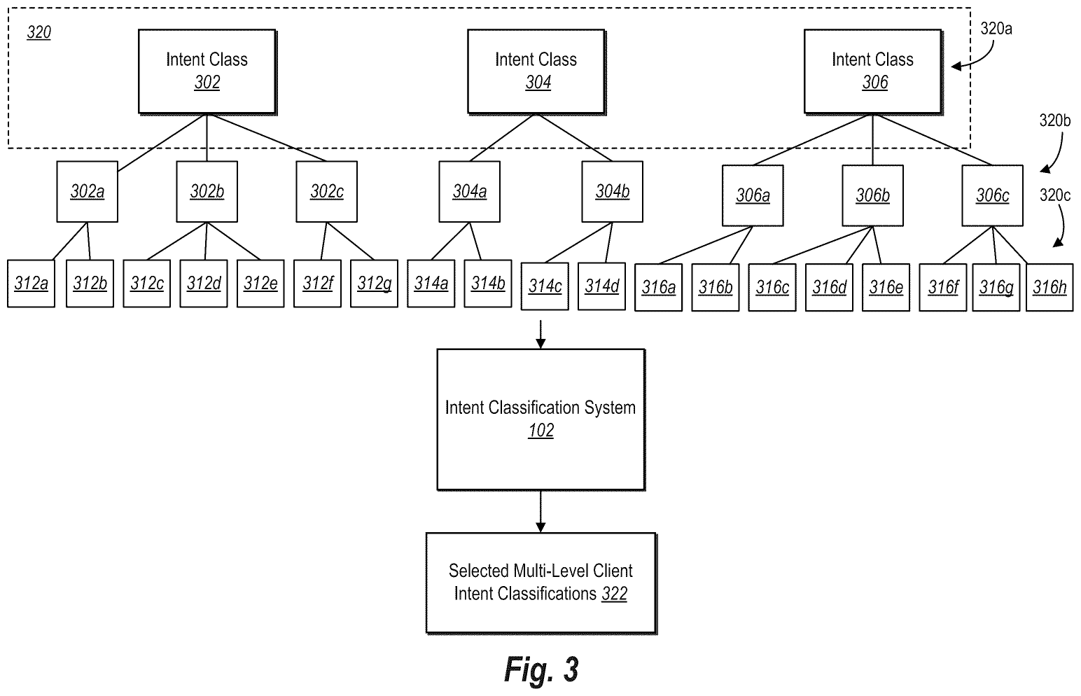

As mentioned above, in some embodiments, the intent classification system 102 identifies multi-level client intent classifications from a hierarchical architecture. For example, FIG. 3 illustrates selecting multi-level client intent classifications from a hierarchical intent architecture 320 in accordance with one or more embodiments.

As illustrated, the hierarchical intent architecture 320 includes a plurality of multi-level client intent classifications organized into a plurality of layers. Specifically, the hierarchical intent architecture 320 includes intent classes 302-306 in a first layer 320a. Each of the intent classes 302-306 corresponds to additional (e.g., children) intent classes in a second layer 320b. For example, the first intent class 302 has children intent classes 302a-302c. The intent classes 302a-302c are more specific sub-classes of the intent class 302.

As illustrated, the intent class 304 also has children intent classes 304a-304b while the intent class 306 has children intent classes 306a-306c. Thus, the children intent classes 302a-302c, 304a-304b, and 306a-306c fall within the second layer 320b of the hierarchical intent architecture 320.

Moreover, as shown, the hierarchical intent architecture 320 also includes a third layer 320c of additional intent classifications. For example, the child intent class 302a has two grandchild intent classes 312a-312b. These intent classes are more specific sub-classes of the child intent class 302a. Indeed, as shown, the child intent classes 302a-302c, 304a-304b, and 306a-306c have grandchild intent classes 312a-312g, 314a-314d, 316a-316h.

As mentioned above, in one or more embodiments, the intent classification system 102 utilizes a machine learning model to generate predicted multi-level client intent classifications and corresponding multi-level client intent classification probabilities. In some implementations, the intent classification system 102 generates multi-level client intent classifications from the most specific layer (e.g., third layer 320c) that include intermediate classifications from parent layers (e.g., the path or chain from the first layer 320a and the second layer 320b, resulting in the third layer 320c).

In some embodiments, the intent classification system 102 can generate predicted multi-level client intent classifications from different layers of the hierarchical intent architecture 320. For example, the intent classification system 102 could select the intent class 302 from the first layer 320a, the intent class 304a from the second layer 320b, and the intent class 316d from the third layer 320c and surface all three intent classes to an agent device.

Additionally, the intent classification system 102 utilizes a machine learning model to generate intent classification probabilities for intent classes in the hierarchical intent architecture 320. As mentioned, in some implementations, the intent classification system 102 generates intent classification probabilities for classes in the final layer (e.g., the probability of a class path that includes a class from the first layer, second layer, and third layer). In some embodiments, the intent classification system 102 generates intent classification probabilities for a subset (e.g., 8, 10, 15 or 20) of the intent classes. In one or more embodiments, the intent classification system 102 generates intent classification probabilities for all of the intent classes. As discussed above with regard to FIG. 2, the intent classification system 102 then selects a subset of the intent classes based on the intent classification probabilities (e.g., the classes with the highest probabilities).

In some embodiments, the intent classification system 102 selects multi-level client intent classifications utilizing both the layer and the intent classification probabilities. In some implementations, the intent classification system 102 rewards intent classes selected from more specific layers (and/or penalizes intent classes selected from more general layers). Thus, for example, the intent classification system 102 can apply a bonus (e.g., a bonus 10% probability or other weight) to intent classes from the second layer 320b relative to the first layer 320a. Similarly, the intent classification system 102 can apply an additional bonus (e.g., a bonus 20% probability or other weight) to input classes from the third layer 320c. In some embodiments, the intent classification system 102 generates an overall selection score by applying a weighted combination to the intent classification probabilities and the layer of the hierarchical intent architecture. Thus, the intent classification system 102 can balance both intent classification probabilities and a level of specificity in identifying intent classes to select.

In some implementations, the intent classification system 102 generates multi-level client intent classifications at different layers for different tasks. For example, for a routing task (e.g., identifying an agent device to route a particular ticket or communication), the intent classification system 102 can generate multi-level client intent classifications at a more general layer (e.g., the first layer 320a or the second layer 320b). For determining a final classification for a ticket or communication, the intent classification system 102 can generate multi-level client intent classifications at a more specific layer (e.g., the third layer 320c). In some implementations, the intent classification system 102 utilizes separate machine learning models for ticket routing and final ticket classification.

Indeed, as just mentioned, in one or more implementations, the intent classification system 102 routes communications or tickets to certain agent devices based on multi-level client intent classifications. For example, the intent classification system 102 can determine at least two predicted multi-client intent classifications related to a particular topic (e.g., direct deposit inquiries). In response, the intent classification system 102 can select an agent device that specializes in the particular topic (i.e., select a direct deposit specialized agent device). Moreover, the intent classification system 102 can then provide the at least two predicted multi-level client intent classifications to the agent device (e.g., based on the selection).

Although FIG. 3 illustrates a particular size and shape of the hierarchical intent architecture 320, the intent classification system 102 can generate and access a variety of different architectures. For example, rather than having three layers, the intent classification system 102 can utilize a hierarchical intent architecture having four, five, or ten layers. Similarly, rather than having three intent classes on the first layer 320a, the intent classification system 102 can utilize a hierarchical intent architecture with five or ten intent classes on the first layer 320a. In addition, some classes in the first layer 320a may have more layers than others (e.g., some classes may have five layers while other classes only have two layers).

Indeed, in some implementations the intent classification system 102 can utilize a hierarchical intent architecture that includes over 1000 different classifications. To illustrate, the hierarchical intent architecture can include a plurality of general contact reasons as the first layer, with 3-4 sublayers (such as a topic, category, subcategory, and issue layer). Thus, for example, a detailed classification can include an “Account Access” topic, a “Biometric Access” category, a “Face Recognition Not Working” subcategory, and an “Android” sub-sub-category. Utilizing another path within the hierarchy could yield an “Account Access” topic, a “Login Issues” category, a “Forgot/Reset Password” sub-category, and a “Wrong SSN” sub-sub-category. Thus, it can be extremely taxing for an agent device to select the most appropriate classification given the sheer number of classification possibilities and channels within the hierarchy.

As mentioned above, the intent classification system 102 can generate and provide user interfaces to agent devices for selecting predicted multi-level client intent classifications. For example, FIGS. 4A-4B illustrate an agent device 400 and a graphical user interface 402 displaying a communication and corresponding multi-level client intent classifications for selection (e.g., for automatic ticket classification). FIG. 4A illustrates various multi-level client intent classifications provided for agent selection via the graphical user interface 402.

As shown in FIG. 4A, the intent classification system 102 generates the graphical user interface 402 including a communication 404. The communication 404 includes a subject line reading “No Access” and text reading “Why can't I get in my account? The app is not working.” The intent classification system 102 includes the communication 404 in the graphical user interface 402 for review by an agent corresponding to the agent device 400.

The intent classification system 102 also generates the graphical user interface 402 to include a client intent panel 410 for selecting a multi-level client intent classification corresponding to the communication 404. Further, the intent classification system 102 generates the client intent panel 410 including one or more predicted multi-level client intent classifications. More specifically, the intent classification system 102 provides the predicted multi-level client intent classifications 412. As mentioned above, the intent classification system 102 utilizes a machine learning model to predict multi-level client intent classifications for the communication 404 based on the text of the communication 404 (and in some embodiments, based on client features associated with the communication 404).

As shown in FIG. 4A, the intent classification system 102 provides the multi-level client intent classifications 412 including information about parent intent classes within a hierarchal intent architecture. More specifically, the multi-level client intent classifications 412 read “account access other access issues service outage” and “account access other access issues incorrect password.” Thus, the predicted multi-level client intent classifications 412 are from the fourth layer of a hierarchical intent architecture and include indicators of classifications from all four layers (e.g., a first classification of “account access” from the first layer, a second classification of “other” from the second layer, a third classification of “access issues” from the third layer, and a fourth classification of “service outage” from the fourth layer). However, the intent classification system 102 can provide the multi-level client intent classifications 412 in a variety of formats and including a variety of multi-level client intent classifications for various communications. More specifically, as mentioned above, the intent classification system 102 determines multi-level client intent classifications for presentation within the graphical user interface 402 by utilizing a machine learning model to analyze the communication 404 and associated client data.

Although the embodiment of FIG. 4A illustrates two recommended multi-level client intent classifications, in some implementations the intent classification system 102 provides a different number of recommended classifications. For example, the intent classification system 102 can surface 3, 4, 5, 10, or more classifications).

Moreover, although the embodiment of FIG. 4A illustrates recommended multi-level client intent classifications from the same layer of a hierarchical intent architecture (e.g., the fourth layer of detail), in some implementations, the intent classification system 102 selects and provides multi-level client intent classifications from different layers of the hierarchical intent architecture 320. For example, the intent classification system 102 can provide a first recommended multi-level client intent classification from a third layer (e.g., that includes indicators of the class from the first, second, and third layers) and a second recommended multi-level client intent classification from a fourth layer (e.g., that includes indicators of the class from the first, second, third, and fourth layers).

Although not illustrated in FIG. 4A, in some implementations, the intent classification system 102 also provides confidence indicators corresponding to the multi-level client intent classifications. For example, the intent classification system can generate a confidence indicator indicating the confidence or intent classification probability corresponding to a particular multi-level client intent classification. The confidence indicator can include a variety of visual characteristics. For example, the intent classification system 102 can modify text color, text size, text format (e.g., underline, bold, etc.), for classifications corresponding to different probabilities. Similarly, the intent classification system 102 can provide a numerical indicator (e.g., from 1 to 100 or 1 to 10) indicating the confidence or probability corresponding to a particular classification. In some implementations, the machine learning platform system 102 can provide a probability corresponding to the classification at each hierarchical layer of a multi-level client intent classification (e.g., 90% confidence of “account access,” 70% confidence of “other,” 50% confidence of “access issues,” and 40% confidence of “service outage”).

Further, in some implementations, the client intent panel 410 provides selectable options corresponding to the predicted multi-level client intent classifications 412. Accordingly, the intent classification system 102 can associate a selected multi-level client intent classifications with the communication 404 based on agent selection within the client intent panel 410. Though FIG. 4A illustrates two predicted multi-level client intent classifications 412 with check boxes as selectable options, it will be appreciated that the intent classification system 102 can generate the graphical user interface 402 including a variety of numbers of multi-level client intent classifications and with a variety of graphical elements for agent selection.

As also shown in FIG. 4A, the client intent panel 410 includes a multi-level client intent classification drop-down menu 414. In response to user interaction via the multi-level client intent classification drop-down menu 414, the intent classification system 102 can provide multi-level client intent classifications organized based on the hierarchal intent architecture. Accordingly, the intent classification system 102 can facilitate agent selection of multi-level client intent classifications that are not included in the predicted multi-level client intent classifications 412.

In some embodiments, the intent classification system 102 provides client intent classification recommendations within the drop-down menu 414 (or some other user interface element that displays available classes at a particular layer). For example, the intent classification system 102 can provide confidence or probability indicators within the drop-down menu to guide agent selection of a particular multi-level client intent classification at each layer. Thus, for example, the intent classification system can provide a first probability indicator (e.g., 70%) next to “Account Access,” a second probability indicator (e.g., 1%) next to “Account Closure & Suspension,” and additional probability indicators for other classes shown for the first layer of the intent hierarchy. The intent classification system 102 can repeat this process through different layers of an intent hierarchy.

For example, in response to selection of “Account Access,” the intent classification system 102 can provide an additional set of selectable options corresponding to a second layer of classifications (e.g., sub-classes for the selected class from the first layer). The intent classification system 102 can provide probability or confidence indicators for each of these classifications at the second layer. In response to a selection at the second layer, the intent classification system 102 can repeat this process for a third layer of intent classifications, and a fourth layer of classifications, etc. In this manner, the intent classification system can efficiently and accurately guide agent selection of an appropriate classification utilizing confidence or probability indicators for each illustrated class.

In one or more implementations, the intent classification system 102 utilizes a combination of recommended multi-level client intent classifications and agent selections of more detailed classes. For example, the intent classification system 102 can provide a recommended multi-level client intent classification at a first level of specificity (e.g., at a second or third layer of the intent hierarchy). The intent classification system 102 can then provide additional sub-classes after the first level of specificity via the drop-down menu 414 (or some other user interface element).

Thus, for example, the intent classification system 102 can determine (above a threshold confidence layer) that a communication corresponds to a particular class at a third layer of the intent hierarchy. In response, the intent classification system 102 can populate the drop-down menu 414 with the fourth layer of child classes dependent on the particular class. In this manner, the intent classification system 102 can focus the agent device on the most pertinent sub-classes and allow the agent device to provide the most pertinent selection (e.g., where the fourth layer classification probabilities fall below a threshold certainty).

In one or more embodiments, the intent classification system 102 receives user selection of a multi-level client intent classification via the multi-level client intent classification drop-down menu 414. As shown in FIG. 4B, in one or more embodiments, the intent classification system 102 provides a confidence notification 416 in the graphical user interface 402 in response to receiving the user selection of the multi-level client intent classification via the multi-level client intent classification drop-down menu 414.

In some implementations, the intent classification system 102 can provide notifications regarding a selected multi-level client intent classification. Indeed, in response to receiving selection of a multi-level client intent classification from an agent device, the intent classification system 102 can compare the selected multi-level client intent classification with the predicted multi-level client intent classification. If a conflict exists (and the multi-level client intent classification probability satisfies a confidence threshold) the intent classification system 102 can surface a notification to an agent device to verify the selected multi-level client intent classification.

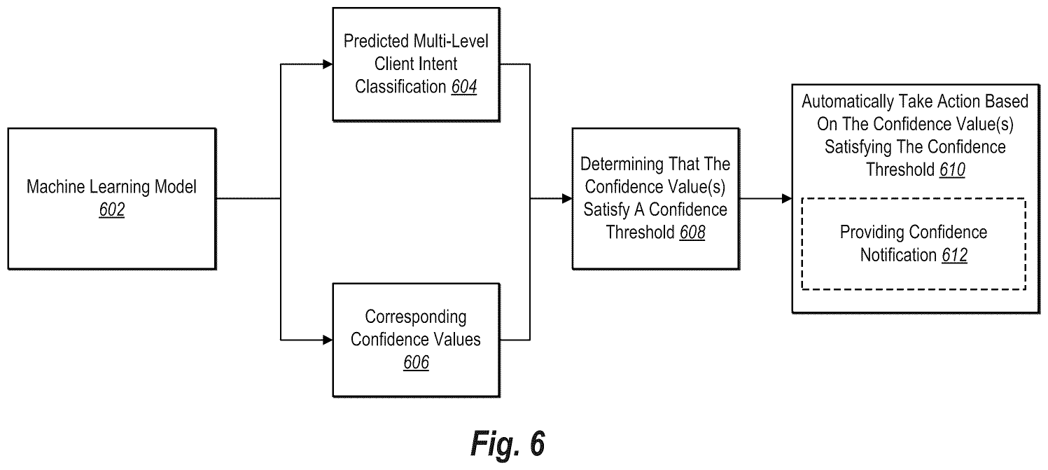

For example, as discussed in greater detail below with regard to FIG. 6, the intent classification system 102 can determine that one or more of the predicted multi-level client intent classifications 412 correspond to multi-level client intent classification probabilities that satisfy a confidence threshold. Based on this determination, the intent classification system 102 can generate and provide the confidence notification 416 indicating the high confidence in one or more of the predicted multi-level client intent classifications 412.

To illustrate, as shown in FIG. 4B, the confidence notification 416 includes the text “Are you sure? We strongly recommend double-checking your client intent classification selection.” However, the intent classification system 102 can generate the confidence notification including a variety of text communicating a degree of certainty associated with the predicted multi-level client intent classifications 412. For example, the intent classification system 102 can generate the confidence notification 416 including options for selecting one or more of the predicted multi-level client intent classifications 412, information about multi-level client intent classification probabilities corresponding to the predicted multi-level client intent classification classifications 412, or other indications of certainty in the predicted multi-level client intent classifications 412.

Upon identifying a multi-class client intent classification (e.g., based on a selection at the agent device), the intent classification system 102 can generate an association between the communication and the multi-class client intent classification. For example, the intent classification system 102 can apply a tag to the communication, add the multi-class client intent classification as a feature within a database of features corresponding to the communication, or add the multi-class client intent classification to metadata of the communication. The intent classification system 102 can then utilize this association for a variety of downstream tasks. For example, the intent classification system 102 can update (e.g., re-train) a machine learning model utilizing the association. Indeed, the intent classification system 102 can utilize the multi-level client intent classification as a ground truth in updating parameters of the machine learning model.

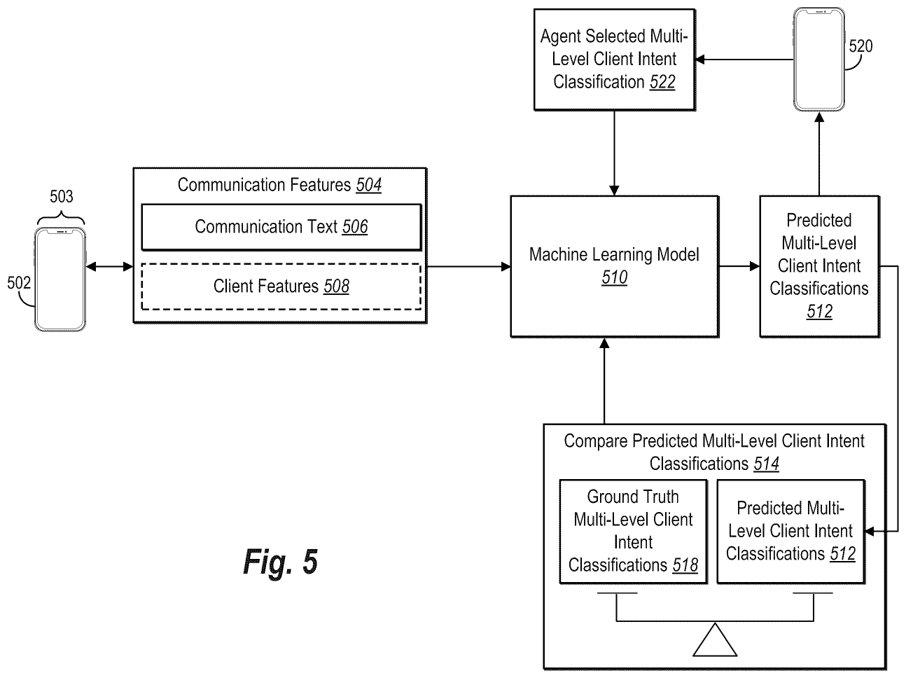

As discussed above, the intent classification system 102 can train the machine learning model for predicting multi-level client intent classifications. For example, FIG. 5 illustrates an overview of monitoring a client device 502 with device application 503 to provide training communication features 504 including communication text 506 and optionally including client features 508 to a machine learning model 510.

As illustrated in FIG. 5, the intent classification system 102 extracts the communication features 504 including the communication text 506 and optionally including the client features 508 that correspond with the client device 502. Accordingly, in one or more embodiments, the intent classification system 102 utilizes the machine learning model 510 to generate predicted multi-level client intent classifications 512.

As shown, the intent classification system 102 can also compare the predicted multi-level client intent classification 512 to agent selected multi-level client intent classifications 522. More specifically, in one or more embodiments, the intent classification system 102 monitors interactions with an agent device 520 to determine the accuracy of the predicted multi-level client intent classification 512. For example, the agent device 520 can detect a user interaction selecting (or declining to select) the predicted multi-level client intent classifications 512 for association with a communication. The intent classification system 102 can determine the ground truth intent from these interactions and can provide these additional interactions to further update the machine learning model 510. Accordingly, the intent classification system 102 monitors the agent device 520 (and/or other agent device interactions) to determine ground truth multi-level client intent classifications and to update the machine learning model 510.

In some implementations, the intent classification system 102 can utilize other sources to determine a ground truth intent. For example, the intent classification system 102 can monitor subsequent communications between an agent device and a client device to determine a ground truth classification. To illustrate, if an agent device selects a template communication that corresponds to a particular intent class, the intent classification system 102 can utilizes the selected template communication and the particular intent class to infer a ground truth intent. Similarly, the intent classification system 102 can monitor subsequent interactions at the client device to determine a ground truth intent (e.g., selection of a particular intent at the client device or interactions with an application that later reveal a particular purpose for the client interaction).

As mentioned, the intent classification system 102 can train the machine learning model 504 by performing an act 514 of comparing predicted multi-level client intent classifications. More specifically, the intent classification system 102 can train the machine learning model 510 by comparing the predicted multi-level client intent classifications 516 with ground truth multi-level client intent classifications 518. In particular, the intent classification system 102 compares the predicted multi-level client intent classifications 516 and the ground truth multi-level client intent classifications 518 with a loss function. A loss function can determine a measure of loss between the predicted multi-level client intent classifications 516 and the ground truth multi-level client intent classifications 518. In some implementations, the intent classification system 102 utilizes a multi-log loss for multi-class classification. The loss function can also include mean absolute error (L1) loss functions, mean squared error (L2) loss functions, cross entropy loss functions, or Kullback-Leibler loss.

In one or more embodiments, the intent classification system 102 trains the machine learning model 510 based on the comparison between the predicted multi-level client intent classifications 516 and the ground truth multi-level client intent classifications 518. For example, the intent classification system 102 can modify internal weights or parameters of a neural network (e.g., via back propagation) to reduce the measure of loss. On subsequent interactions between agent devices, client devices, and the intent classification system 102, the machine learning model 510 provides improved predicted multi-level client intent classifications.

In one or more embodiments, the intent classification system 102 improves training efficiency and accuracy by filtering certain intent classes. For example, the intent classification system 102 can remove classes that do not have a threshold number of training samples. Indeed, the intent classification system 102 can address inaccuracy and inefficiency resulting from long-tail classes by removing those classes in training.

Upon training, the intent classification system 102 can utilize the machine learning model 510 to further generate predicted multi-level client intent classifications. For example, in some embodiments, the intent classification system 102 generates provides multi-level client intent classifications based on receiving communications from client devices. More specifically, the intent classification system 102 can provide predicted multi-level client intent classifications to agent devices alongside the client communication.

Moreover, as discussed above, the intent classification system 102 can also utilize multi-level client intent classifications for additional downstream tasks. For example, the intent classification system 102 can provide multi-level client intent classifications to a machine learning service for training a variety of different machine learning models. Indeed, the intent classification system 102 can implement a variety of machine learning models for various purposes, such as automated interactions with client devices, text thread responses, security prediction, approval models, risk analysis, or client device authentication. The intent classification system 102 can provide accurate multi-level client intent classifications to these machine learning services to utilize as input features, training features, or ground truths. For example, the intent classification system 102 can provide the multi-level client intent classifications to a risk or fraud analysis model, which can process the multi-level client intent classifications to make a risk/fraud prediction for associated client accounts. Similarly, machine learning models for generating security predictions, transaction or process approval predictions, client device authentication predictions can utilize previous multi-level client intent classifications as input features. In addition, other intent prediction models can utilize the multi-level client intent classifications as ground truths in training the other intent prediction models.

The intent classification system 102 can also utilize the multi-level client intent classifications to modify computer implemented process. For example, the intent classification system 102 can assign computer or engineering resources to different models or processes depending on the number of multi-level client intent classifications received over a period of time for particular classes. Thus, for example, if the intent classification system 102 receives a significant number of tickets regarding account outages, the intent classification system 102 can modify resources to address outage problems.

As briefly mentioned above, in one or more embodiments, the intent classification system 102 utilizes one or more confidence thresholds. FIG. 6 illustrates utilizing a confidence threshold to take automatic action in response to a communication. As shown in FIG. 6, and as discussed above, a machine learning model 602 can generate predicted multi-level client intent classifications 604 and corresponding confidence values 606. In one or more embodiments, the corresponding confidence values 606 are multi-level client intent classification probabilities.

As shown in FIG. 6, the intent classification system 102 performs an act 608 of determining that the confidence value(s) satisfy a confidence threshold. Similar to discussion above with regard to FIG. 2, the classification system 102 can determine a value for a confidence threshold in a variety of ways, such as based on user input. In addition, or in the alternative, the intent classification system 102 can determine a value for a confidence threshold based on historical user interactions with automated system action. For example, the intent classification system 102 can select a confidence threshold at which 90% of user interactions with the automated system action are positive.

Further, as shown in FIG. 6, the intent classification system 102 can perform an act 610 of automatically taking action based on the confidence value(s) satisfying the confidence threshold. To illustrate, in one or more embodiments, the intent classification system 102 utilizes an intent classification threshold to determine whether to take an action associated with the multi-level client intent classification. In one or more embodiments, the intent classification system 102 determines that the top predicted multi-level client intent classification is associated with a multi-level client intent classification probability that satisfies the intent classification threshold. Based on this determination, the intent classification system 102 can take an action associated with the multi-level client intent classification. For example, the intent classification system 102 generates an automatic reply to the communication with instructions corresponding to the multi-level client intent classification, automatically makes changes to one or more account settings for an account associated with the communication, or refers the communication to a particular device (e.g., a specific agent device).

As mentioned above with regard to FIG. 4B, act 610 can include an act 612 of providing a confidence notification. To illustrate, in one or more embodiments, the intent classification system 102 can generate a notification in response to determining that the multi-level client intent classification probabilities satisfy a confidence threshold. In one or more embodiments, the intent classification system 102 generates the confidence notification to include an indication of a high probability of accuracy with regard to one or more multi-level client intent classifications provided to an agent device via a graphical user interface. As mentioned above, in one or more embodiments, the intent classification system 102 provides the confidence notification in response to agent selection of an alternate multi-level client intent classification.

The intent classification system 102 can utilize a variety of different confidence thresholds. For example, the intent classification system 102 can utilize a first threshold to surface a particular multi-level client intent classification to an agent device. The intent classification system 102 can also utilize a second threshold to surface a reminder or notification if the agent device selects a different class. Moreover, the intent classification system 102 can utilize a third threshold to automatically transmit a responsive communication to a client device. In some implementations, the intent classification system 102 can also utilize a fourth threshold and/or intent class to prioritize particular communications or tickets (e.g., escalate particular communications to agent devices in a prioritized manner where the intent classification indicates imminent loss or change such as fraud or account takeovers). In one or more implementations, the intent classification system 102 utilizes a fifth threshold to automatically populate an intent classification for a communication (e.g., bypassing confirmation by an agent device).

In some implementations, the intent classification system 102 utilizes a voting (e.g., majority voting) approach. For example, in one or more embodiments, the intent classification system 102 can determine class predictions for a detailed layer to vote in surfacing an intent classification from a more general layer. To illustrate, the intent classification system 102 can identify the top five classification intents at a fourth layer of an intent hierarchy. The intent classification system 102 can utilize the classification intents at the fourth layer to surface a classification at the third layer (or the second layer) of the intent hierarchy. For example, if three of the top five classification intents belong to the same parent class at the third layer, then (by majority vote of 3), the intent classification system 102 can surface the parent class from the third layer as a recommended multi-level client intent classification to an agent device.

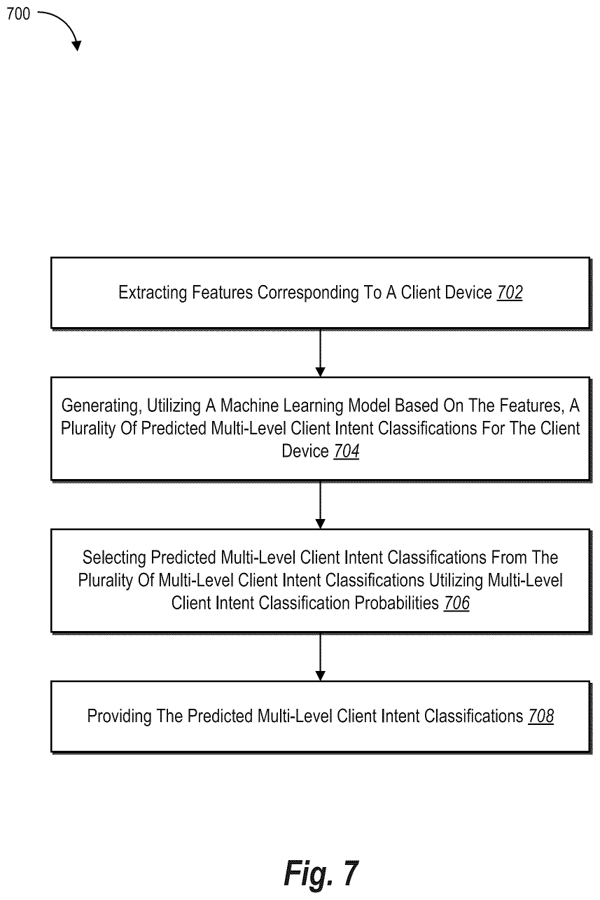

FIGS. 1-6, the corresponding text, and the examples provide a number of different methods, systems, devices, and non-transitory computer-readable media of the intent classification system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for utilizing a machine-learning model to determine multi-level client intent classifications in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 includes an act 702 for extracting features corresponding to a client device. In particular, the act 702 can include extracting features corresponding to a client device, in response to receiving a communication from the client device. Specifically, the act 702 can include wherein extracting the features corresponding to the client device comprises at least one of extracting text from the communication, extracting user activity data, or extracting user profile data.

As shown in FIG. 7, the series of acts 700 includes an act 704 for generating, utilizing a machine learning model based on the features, a plurality of predicted multi-level client intent classifications for the client device. In particular, the act 704 can include generating, utilizing a machine learning model based on the features, a plurality of predicted multi-level client intent classifications for the client device, from a hierarchical intent architecture, and corresponding multi-level client intent classification probabilities. Specifically, the act 704 can include updating the machine learning model utilizing the association between the multi-level client intent classification and the communication. Additionally, the act 704 can include wherein the machine-learning model comprises a transformer encoder and a classification layer. Further, the act 704 can include generating the hierarchical intent architecture by generating a first sent of intent classifications at a first level and a second set of client intent classifications at a second level that depend from the first set of intent classifications.

As shown in FIG. 7, the series of acts 700 includes an act 706 for selecting predicted multi-level client intent classifications from the plurality of multi-level client intent classifications utilizing multi-level client intent classification probabilities. In particular, the act 706 can include selecting at least two predicted multi-level client intent classifications from the plurality of multi-level client intent classifications utilizing the multi-level client intent classification probabilities.

As shown in FIG. 7, the series of acts 700 includes an act 708 for providing the predicted multi-level client intent classifications. In particular, the act 708 can include providing, via a graphical user interface of an agent device, the at least two predicted multi-level client intent classifications for association with the communication. Specifically, the act 708 can include receiving, via the graphical user interface of the agent device, a selection of a multi-level client intent classification of the at least two predicted multi-level client intent classifications, and based on the received selection, generating an association between the multi-level client intent classification and the communication.

Additionally, in one or more embodiments, the act 708 includes selecting the agent device based on the at least two predicted multi-level client intent classifications, and providing the at least two predicted multi-level client intent classifications based on the selection of the agent device. Further, in some embodiments, the act 708 includes, in response to receiving an additional communication transmitted from the client device, generating, utilizing the machine learning model based on the multi-level client intent selected for the communication, an additional plurality of predicted multi-level client intent classifications for the additional communication

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 (e.g., the client device 108, or the server(s) 106) that may be configured to perform one or more of the processes described above. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output interface 808 (or “I/O interface 808”), which are provided to allow a user (e.g., requester or provider) to provide input to (such as user strokes), receive output from, and otherwise transfer data to and from the computing device 800. These I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that connects components of computing device 800 to each other.

FIG. 9 illustrates an example network environment 900 of the inter-network facilitation system 104. The network environment 900 includes a client device 906 (e.g., client device 108), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation system 104, third-party systems 908, and networks 904, this disclosure contemplates any suitable number of client devices 906, inter-network facilitation system 104, third-party systems 908, and networks 904. As an example, and not by way of limitation, network environment 900 may include multiple client device 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906 and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 9. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party-system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
extracting features corresponding to a client device, in response to receiving a communication from the client device;
generating, utilizing a machine learning model based on the features, a plurality of predicted multi-level client intent classifications for the client device, from a hierarchical intent architecture, and corresponding multi-level client intent classification probabilities;
selecting at least two predicted multi-level client intent classifications from the plurality of multi-level client intent classifications utilizing the multi-level client intent classification probabilities; and
providing, via a graphical user interface of an agent device, the at least two predicted multi-level client intent classifications for association with the communication.

2. The method of claim 1, further comprising:
receiving, via the graphical user interface of the agent device, a selection of a multi-level client intent classification of the at least two predicted multi-level client intent classifications; and
based on the received selection, generating an association between the multi-level client intent classification and the communication.

3. The method of claim 2, further comprising updating the machine learning model utilizing the association between the multi-level client intent classification and the communication.

4. The method of claim 1, further comprising:
selecting the agent device based on the at least two predicted multi-level client intent classifications; and
providing the at least two predicted multi-level client intent classifications based on the selection of the agent device.

5. The method of claim 1, wherein extracting the features corresponding to the client device comprises at least one of extracting text from the communication, extracting user activity data, or extracting user profile data.

6. The method of claim 1, wherein the machine-learning model comprises a transformer encoder and a classification layer.

7. The method of claim 2, further comprising, in response to receiving an additional communication transmitted from the client device, generating, utilizing the machine learning model based on the multi-level client intent selected for the communication, an additional plurality of predicted multi-level client intent classifications for the additional communication.

8. The method of claim 1, further comprising generating the hierarchical intent architecture by generating a first sent of intent classifications at a first level and a second set of client intent classifications at a second level that depend from the first set of intent classifications.

9. A non-transitory computer-readable medium storing instructions that, when executed by at least one processor, cause a computer system to:
extract features corresponding to a client device, in response to receiving a communication from the client device;
generate, utilizing a machine learning model based on the features, a plurality of predicted multi-level client intent classifications for the client device, from a hierarchical intent architecture, and corresponding multi-level client intent classification probabilities;
select at least two predicted multi-level client intent classifications from the plurality of multi-level client intent classifications utilizing the multi-level client intent classification probabilities; and
provide, via a graphical user interface of an agent device, the at least two predicted multi-level client intent classifications for association with the communication.

10. The non-transitory computer-readable medium of claim 9, wherein the instructions, when executed by the at least one processor, further cause the computer system to:
receive, via the graphical user interface of the agent device, a selection of a multi-level client intent classification of the at least two predicted multi-level client intent classifications; and
based on the received selection, generate an association between the multi-level client intent classification and the communication.

11. The non-transitory computer-readable medium of claim 10, wherein the instructions, when executed by the at least one processor, further cause the computer system to update the machine learning model utilizing the association between the multi-level client intent classification and the communication.

12. The non-transitory computer-readable medium of claim 9, wherein the instructions, when executed by the at least one processor, further cause the computer system to:
select the agent device based on the at least two predicted multi-level client intent classifications; and
provide the at least two predicted multi-level client intent classifications based on the selection of the agent device.

13. The non-transitory computer-readable medium of claim 9, wherein the instructions, when executed by the at least one processor, further cause the computer system to:
extract the features corresponding to the client device by performing at least one of extracting text from the communication, extracting user activity data, or extracting user profile data.

14. The non-transitory computer-readable medium of claim 9, wherein the machine-learning model comprises a transformer encoder and a classification layer.

15. The non-transitory computer-readable medium of claim 10, wherein the instructions, when executed by the at least one processor, further cause the computer system to generate, utilizing the machine learning model based on the multi-level client intent selected for the communication, an additional plurality of predicted multi-level client intent classifications for the additional communication.

16. The non-transitory computer-readable medium of claim 9, wherein the instructions, when executed by the at least one processor, further cause the computer system to generate the hierarchical intent architecture by generating a first sent of intent classifications at a first level and a second set of client intent classifications at a second level that depend from the first set of intent classifications.

17. A system comprising:
at least one processor; and
at least one non-transitory computer-readable storage medium storing instructions that, when executed by the at least one processor, cause the system to:
extract features corresponding to a client device, in response to receiving a communication from the client device;
generate, utilizing a machine learning model based on the features, a plurality of predicted multi-level client intent classifications for the client device, from a hierarchical intent architecture, and corresponding multi-level client intent classification probabilities;
select at least two predicted multi-level client intent classifications from the plurality of multi-level client intent classifications utilizing the multi-level client intent classification probabilities; and
provide, via a graphical user interface of an agent device, the at least two predicted multi-level client intent classifications for association with the communication.

18. The system of claim 17, further comprising instructions that, when executed by the at least one processor, cause the system to:
receive, via the graphical user interface of the agent device, a selection of a multi-level client intent classification of the at least two predicted multi-level client intent classifications; and
based on the received selection, generate an association between the multi-level client intent classification and the communication.

19. The system of claim 18, further comprising instructions that, when executed by the at least one processor, cause the system to update the machine learning model utilizing the association between the multi-level client intent classification and the communication.

20. The system of claim 17, further comprising instructions that, when executed by the at least one processor, cause the system to:
select the agent device based on the at least two predicted multi-level client intent classifications; and
provide the at least two predicted multi-level client intent classifications based on the selection of the agent device.
